(19) United States
(12) Patent Application Publication
(10) Pub. No.: US 2006/0187289 A1
(43) Pub. Date: Aug. 24, 2006

(54) Image forming apparatus

(75) Inventor: Atsuhisa Nakashima, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 11/356,207

(22) Filed: Feb. 17, 2006

(30) Foreign Application Priority Data
Feb. 18, 2005 (JP) 2005-042695

(51) Int. Cl. B41J 2/01

(52) U.S. Cl. 347/104

(57) ABSTRACT

A tension roller is urged by a compression spring, and a position at which the tension roller contacts with a conveyance belt is set to a position coming close to a driven roller rather than a drive roller in such a manner as to prevent a portion of the conveyance belt, the portion pushed out by the drive roller, from being vibrated, and prevent the vibration from being transmitted to a portion of the conveyance belt, the portion on a passing region side of a recording medium (an encoder roller side), so as to run around the driven roller.

### CROSS-REFERENCE TO RELATED APPLICATIONS

This Nonprovisional application claims priority under 35 U.S.C. §119(a) on Patent Application No. 2005-042695 filed in Japan on Feb. 18, 2005, the entire contents of which are hereby incorporated by reference.

### BACKGROUND

The present invention relates to an image forming apparatus, and more particularly to an image forming apparatus which can suppress a vibration of a conveyance belt and can accurately detect a conveying speed of the conveyance belt.

A line type printer, for example, is provided mainly with an endless conveyance belt conveying a recording medium, a drive roller and a driven roller around which the conveyance belt is wound, and drive means for driving the drive roller, transmits a drive force by the drive means to the conveyance belt via the drive roller, and ejects ink from the recording head while conveying the recording medium by the conveyance belt, thereby forming a desired image on the recording medium.

In this case, a resolution of the image formed on the recording medium depends on conveying accuracy of the recording medium. Accordingly, in order to form the image having high accuracy, it is necessary to accurately drive the conveyance belt at a predetermined conveying speed.

For example, in Japanese Patent Application Laid-Open No. 5-297737 (1993), there is disclosed a technique in which an endless conveyance belt is pinched by a speed detection roll (an encoder roller) to which a rotary encoder is attached, and an opposed roll urged in a direction heading for the speed detection roll, and a drive of the conveyance belt is controlled on the basis of a rotational position of the speed detection roll detected by the rotary encoder.

### SUMMARY

In recent years, in order to improve a print quality, it is required to stably feed the conveyance belt at high accuracy. In response to such a request, the present inventor has conceived of a structure in which a drive roller is arranged in a downstream side in a conveying direction of a recording medium, and a driven roller is arranged in an upstream side. In accordance with this structure, a portion of the conveyance belt, the portion in a region conveying the recording medium, is pulled toward the drive roller in the downstream side from the driven roller in the upstream side on the basis of the rotation of the drive roller so as to be in a tension state. Accordingly, the portion in the region conveying the recording medium is stably fed at high feeding accuracy.

However, in accordance with this structure, a surplus state is formed in a portion of the conveyance belt, the portion pushed out by the drive roller, (a portion which does not contribute to the conveyance of the recording medium), and the portion of the conveyance belt under the surplus state bends (undulates), so that there is a problem that the vibration is generated. The vibration is transmitted to the portion of the conveyance belt under the tension state by going around the driven roller. Accordingly, there is a problem that the speed detection roller (the encoder roller) can not follow a fluctuation of the conveyance belt, and that it is impossible to accurately detect the conveying speed of the conveyance belt.

Accordingly, in order to solve the problems mentioned above, an object is to provide an image forming apparatus capable of suppressing the vibration of the conveyance belt and accurately detecting the conveying speed of the conveyance belt.

In order to achieve the above object, an image forming apparatus according to a first aspect is an image forming apparatus comprising: an endless conveyance belt having an outer peripheral surface which serves as a mounting surface of a recording medium; a drive roller and a driven roller around which the conveyance belt is wound; a driving unit driving the drive roller; an encoder roller contacting with a portion of the conveyance belt, the portion moving toward the drive roller from the driven roller; an encoder detecting a rotational position of the encoder roller; a tension roller contacting with a portion of the conveyance belt, the portion moving toward the driven roller from the drive roller; a first urging unit urging the tension roller toward the conveyance belt; and a recording head ejecting ink to the recording medium conveyed by the conveyance belt, wherein a position at which the tension roller contacts with the conveyance belt is set to a position at which a length of the conveyance belt between the driven roller and the tension roller is shorter than a length of the conveyance belt between the tension roller and the drive roller.

In the image forming apparatus according to the first aspect, when the drive roller is driven by the driving unit, the conveyance belt is fed via the rotational drive force of the drive roller, and the recording medium mounted on the outer peripheral surface of the conveyance belt is conveyed. Further, when the conveyance belt is fed, the encoder roller contacting with the conveyance belt is rotated in an interlocking manner, and the rotational position of the encoder roller is detected by the encoder.

The tension roller contacting with the conveyance belt is urged toward the conveyance belt by the first urging unit. Accordingly, a predetermined tension is applied to the conveyance belt, and a slip between the conveyance belt and the drive roller is suppressed. As a result, it is possible to securely transmit the rotational force of the drive roller to the conveyance belt so as to stably feed the conveyance belt at a speed corresponding to the rotational speed of the drive roller.

In this case, the position at which the tension roller contacts with the conveyance belt is set to the position at which the length of the conveyance belt between the driven roller and the tension roller is shorter than the length of the conveyance belt between the tension roller and the drive roller.

In other words, since the tension roller is arranged at the position coming close to the driven roller rather than the drive roller, it is possible to effectively prevent a portion of the conveyance belt, the portion pushed out by the drive roller, from being vibrated even when rotating the drive roller (the conveyance belt) at the high speed, and there can be obtained an effect that it is possible to effectively prevent the vibration from being transmitted to a portion of the conveyance belt, the portion on a passing region side of the recording medium (that is, a side in which the encoder roller is positioned), in such a manner as to go around the driven roller.

As a result, since it is possible to stably rotate the encoder roller at the rotational speed corresponding to the conveying speed of the conveyance belt while solving the problem that the encoder roller can not follow the fluctuation of the conveyance belt due to an influence of the vibration, it is possible to accurately detect the conveying speed of the conveyance belt, and there can be obtained an effect that it is possible to improve an image quality.

The above and further objects and features will more fully be apparent from the following detailed description with accompanying drawings.

### BRIEF DESCRIPTION OF THE SEVERAL VIEWS OF THE DRAWINGS

FIG. 1 is a schematic view of an image forming apparatus according to a first embodiment;

FIG. 2 is a top view of a conveying unit as seen from a recording head side;

FIG. 3 is a partly sectional view of the conveying unit;

FIG. 4 is an electric block diagram of a control unit;

FIG. 5 is a sectional side view of the conveying unit taken along a line V-V in FIG. 2; and

FIG. 6 is a sectional side view of a conveying unit according to a second embodiment.

### DETAILED DESCRIPTION OF THE EXEMPLARY EMBODIMENTS

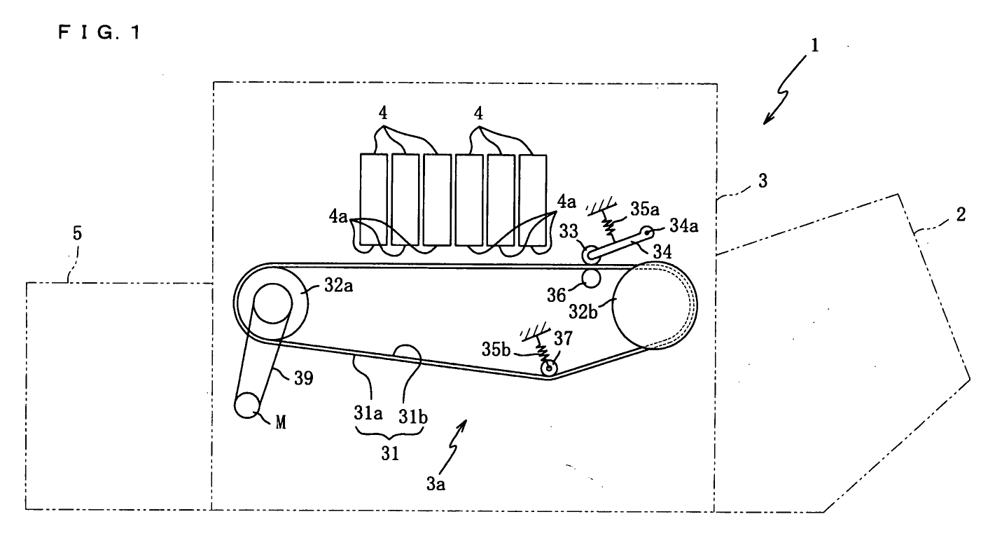

Hereinafter, description will be given of preferred embodiments with reference to the accompanying drawings. FIG. 1 is a schematic view of an image forming apparatus 1 according to a first embodiment. In FIG. 1, compression springs 35a and 35b are simplified, and a supply unit 2 and a discharge unit 5 are schematically illustrated respectively by two-dot chain lines. First, a description will be given of an entire structure of the image forming apparatus 1 with reference to FIG. 1.

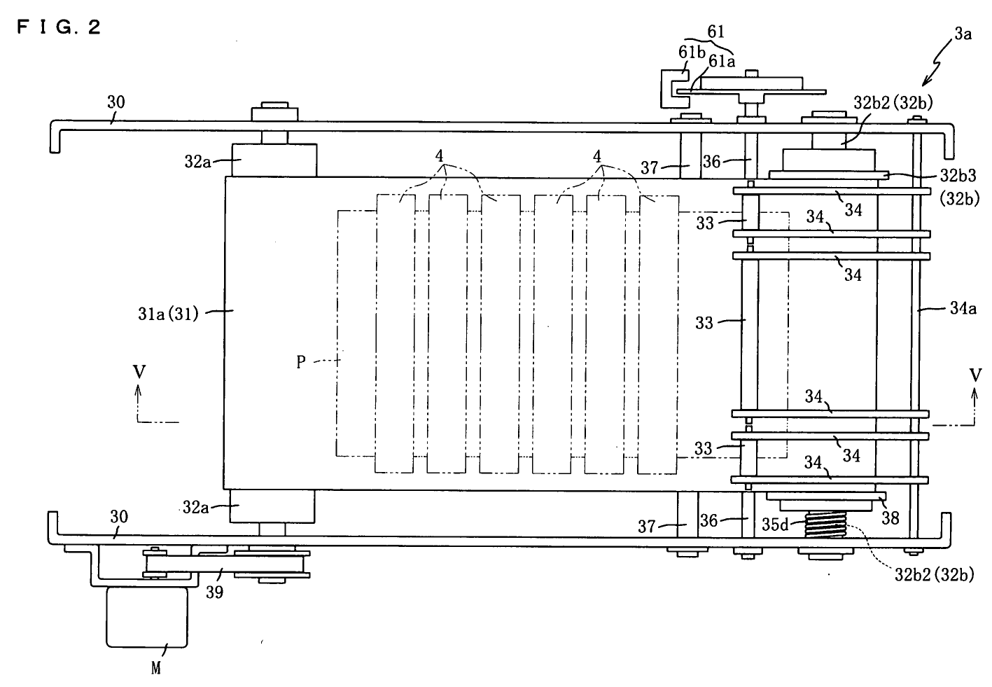

The image forming apparatus 1 is structured as a so-called line type printer, and is mainly provided with the supply unit 2 supplying a recording medium P (see FIG. 2) to a main body unit 3, a main body unit 3 forming an image on the recording medium P supplied by the supply unit 2, and the discharge unit 5 accommodating the recording medium P discharged from the main body unit 3.

The supply unit 2 is provided with a tray accommodating the recording medium P, and a pickup roller come into contact with the recording medium P accommodated in the tray (none of them is illustrated), and the recording medium P within the tray is supplied to a conveying unit 3a of the main body unit 3 one by one in accordance with a rotational drive of the pickup roller.

A recording medium conveyance path for conveying the recording medium P supplied from the supply unit 2 toward the discharge unit 5 is formed in the conveying unit 3a. The recording medium conveyance path is mainly formed by an endless conveyance belt 31 wound around a drive roller 32a and a driven roller 32b.

An outer peripheral surface 31a of the conveyance belt 31 (that is, a surface in a side holding and conveying the recording medium P) is subjected to silicone treatment. Thus, the conveyance belt 31 is moved in a circulating manner (a counterclockwise in FIG. 1) by being fed by a rotational drive force transmitted from the drive roller 32a while holding the recording medium P due to an adhesive force thereof, and conveys the recording medium P supplied from the supply unit 2 in an upstream side in a conveying direction (a right side in FIG. 1) toward the discharge unit 5 in a downstream side in the conveying direction (a left side in FIG. 1). It should be noted that the drive roller 32a is rotated by a rotational drive force of a drive motor M (a driving unit) transmitted via a transmission belt 39.

As shown in FIG. 1, a nip roller 33 and an encoder roller 36 are arranged in an upstream side of the recording medium conveyance path (a right side in FIG. 1) so as to face to each other while pinching the conveyance belt 31. Further, a tension roller 37 is arranged in a lower side of the encoder roller 36 (a lower side in FIG. 1).

The nip roller 33 corresponds to a rotating member pressing the recording medium P against the conveyance belt 31 and provided for preventing the recording medium P from floating up, and contacts with an outer peripheral surface 31a of the conveyance belt 31. Further, the encoder roller 36 corresponds to a rotating member for detecting a conveying speed of the conveyance belt 31 by rotating in conjunction with the conveyance belt 31, and contacts with an inner peripheral surface 31b of the conveyance belt 31.

The nip roller 33 is pivotally supported to an arm portion 34 so as to be rotatable, and is urged in a direction coming close to the encoder roller 36 (a lower side in FIG. 1). In other words, a compression spring 35a (a fourth urging unit) is connected to the arm portion 34 capable of swinging about a shaft portion 34a in a compressed state, as shown in FIG. 1, and the nip roller 33 is urged toward the lower side in FIG. 1 due to an elastic restoring force of the compression spring 35a.

As mentioned above, the encoder roller 36 also serves as a role of a pinching roller supporting the nip roller 33 in addition to a role of detecting the conveying speed of the conveyance belt 31. As a result, it is possible to reduce a parts cost and an assembling cost by reducing a number of parts, and it is possible to reduce a product cost as an entire of the image forming apparatus 1 at that degree.

Further, since the compression spring 35a is structured such as to urge the nip roller 33, it is not necessary to structure the encoder roller 36 so as to be freely movable in an urging direction or an opposite direction thereto. Therefore, since it is possible to simplify the structure for holding the encoder roller 36, it is possible to improve reliability thereof, and it is possible to more accurately detect the conveying speed of the conveyance belt 31.

The tension roller 37 corresponds to a member for applying a tension to the conveyance belt 31 and preventing the vibration of the conveyance belt 31, contacts with the inner peripheral surface 31b of the conveyance belt 31, and is pivotally supported so as to rotate in conjunction with the conveyance belt 31. Further, the tension roller 37 is arranged in a side coming close to the driven belt 32b (a right side in FIG. 1) rather than the drive belt 32a.

It should be noted that a compression spring 35b (a first urging unit) is connected to the tension roller 37 in a compressed state, and the tension roller 37 is urged toward the outer peripheral surface 31a side of the conveyance belt 31 from the inner peripheral surface 31b side, due to the elastic restoring force of the compression spring 35b.

It should be noted that, in the present embodiment, since an outer peripheral surface of the tension roller 37 is made of an elastic material, it is possible to suppress the vibration of the conveyance belt 31 due to a vibration suppressing effect of the elastic material.

Here, as the elastic material, a rubber-based elastic material, urethane resin and the like is exemplified. For example, since it is possible to achieve a vibration damping function and a vibration isolating function due to a viscous effect and a vibration suppressing effect by using a material having the viscous effect such as the rubber-based elastic material or the like, it is possible to damp the vibration of the conveyance belt 31, and it is possible to shut off the transmission of the vibration of the conveyance belt 31 to the main body frame 30 (see FIG. 2) via the tension roller 36.

A plurality of (six in the present embodiment) recording heads 4 are provided in an upper side of the conveyance belt 31 (an upper side in FIG. 1) in parallel with a conveying direction of the recording medium P. Each of the recording heads 4 is structured in an elongated rectangular parallelepiped shape, and is arranged such that a longitudinal direction thereof is directed to a width direction of the recording medium P (a vertical direction to a paper surface in FIG. 1).

A plurality of ink ejecting holes ejecting ink are formed in a bottom surface (an ink ejection surface) 4a of each of the recording heads 4. Colors of ink ejected from six recording heads 4 are different from each other, and are constituted by cyan, light cyan, magenta, light magenta, yellow and black.

A predetermined gap is formed between bottom surfaces 4a of the recording heads 4 and the conveyance belt 31, and the recording medium P passes through the gap. Further, the ink is ejected toward the upper surface of the recording medium P at a time of passing through a lower side (a lower side in FIG. 1) of each of the ink ejecting holes, whereby a desired color image is formed on the recording medium P.

It should be noted that a ejection timing of the ink at a time of ejecting the ink from each of the recording heads 4 is controlled on the basis of a conveying speed of the conveyance belt 31 detected by the encoder roller 36, as mentioned below.

Further, in the present embodiment, each of the recording heads 4 is structured such as to freely move up and down in a vertical direction (a vertical direction in FIG. 1), and maintenance means (such as a cap and a pump for a purge operation or the like, not illustrated) can be arranged between facing surfaces of each of the recording heads 4 (the bottom surface 4a) and the conveyance belt 31, at a time of maintenance.

Next, a description will be given of a detailed structure of the conveying unit 3a with reference to FIG. 2. FIG. 2 is a top view of the conveying unit 3a as seen from the recording head 4 side. It should be noted that, in FIG. 2, the recording heads 4 and the recording medium P are schematically illustrated by two-dot chain lines, and an illustration of the compression spring 35a urging the arm portion 34 is omitted.

The main body frame 30 corresponds to a member forming a frame of the main body unit 3, and is formed by press working a metal material and constructed from a pair of sub-frames arranged at a predetermined interval while facing to each other. Both ends in an axial direction (a vertical direction in FIG. 2) of the drive roller 32a, the driven roller 32b, the encoder roller 36 and the tension roller 37 are pivotally supported to the main body frame 30 so as to be rotatable, as shown in FIG. 2.

Further, a shaft portion 34a is firmly fixed to an end in an opposite side to the nip roller 33 (a right side in FIG. 2), in the arm portion 34 supporting the nip roller 33 pivotally, and the shaft portion 34a is pivotally supported to the main body frame so as to be rotatable. Accordingly, the nip roller 33 can move about the shaft portion 34a toward the encoder roller 36 side (a back side of the paper surface in FIG. 1) or an opposite side (a front side of the paper surface in FIG. 1).

The encoder roller 36 extends in parallel to the nip roller 33, that is, in a width direction (a vertical direction in FIG. 2) of the conveyance belt 31, as shown in FIG. 2. A rotary encoder 61 (an encoder) is arranged in an outer side of the main body frame 30, in one end side (an upper side in FIG. 2) in an axial direction of the encoder roller 36.

The rotary encoder 61 corresponds to a device for detecting a rotational position of the encoder roller 36, and is provided with a slit plate 61a and an optical sensor 61b. The slit plate 61a corresponds to a disc-shaped body firmly fixed to the encoder roller 36, and a plurality of slits are formed in an outer edge of the disc-shaped body. The optical sensor 61b is fixed to a position capable of detecting a slit of the slit plate 61a.

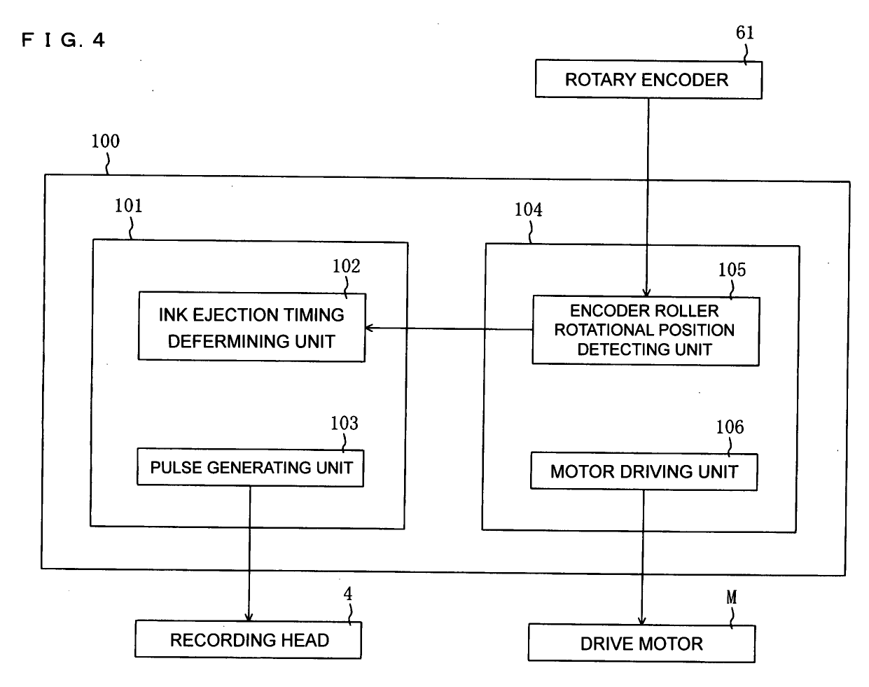

In accordance with the rotary encoder 61, when the conveyance belt 31 is fed, the encoder roller 36 rotates in conjunction with the conveyance belt 31, and the slit plate 61a firmly fixed to the encoder roller 36 rotates. Further, when the slit plate 61a rotates at a predetermined angle, the optical sensor 61b detects the pass of the slit of the slit plate 61a, and outputs a detection signal to a control unit 100 (see FIG. 4) mentioned below.

The control unit 100 calculates a rotational position of the encoder roller 36 (that is, the conveying speed of the conveyance belt 31) on the basis of the input detection signal, and controls each of the recording heads 4 in such a manner as to eject the ink at a ejection timing corresponding to the conveying speed.

A transmission belt 39 is coupled to one end side (a lower side in FIG. 2) in an axial direction of the drive roller 32a, as shown in FIG. 2, and the transmission belt 39 is coupled to the rotational shaft of the drive motor M. Accordingly, when the rotational shaft of the drive motor M is rotated, the rotation is transmitted to the drive roller 32a via the transmission belt 39, so that the conveyance belt 31 is fed.

The tension roller 37 extends in parallel to the drive roller 32a and the driven roller 32b, that is, in the width direction (the vertical direction in FIG. 2) of the conveyance belt 31, as shown in FIG. 2. As mentioned above, the tension roller 37 is urged toward the outer peripheral surface 31a side from the inner peripheral surface 31b side of the conveyance belt 31, by the compression spring 35b (see FIG. 1).

Accordingly, the tension roller 37 is pivotally supported to an opening (not shown) in the shape of an elongate hole formed in the main body frame 30, and is pivotally supported so as to be slidable in an urging direction by the compression spring 35b (a back direction of the paper surface in FIG. 2) or an opposite direction (a front direction of the paper surface in FIG. 2) by using, as the guide, the edge of the opening in the shape of an elongate hole.

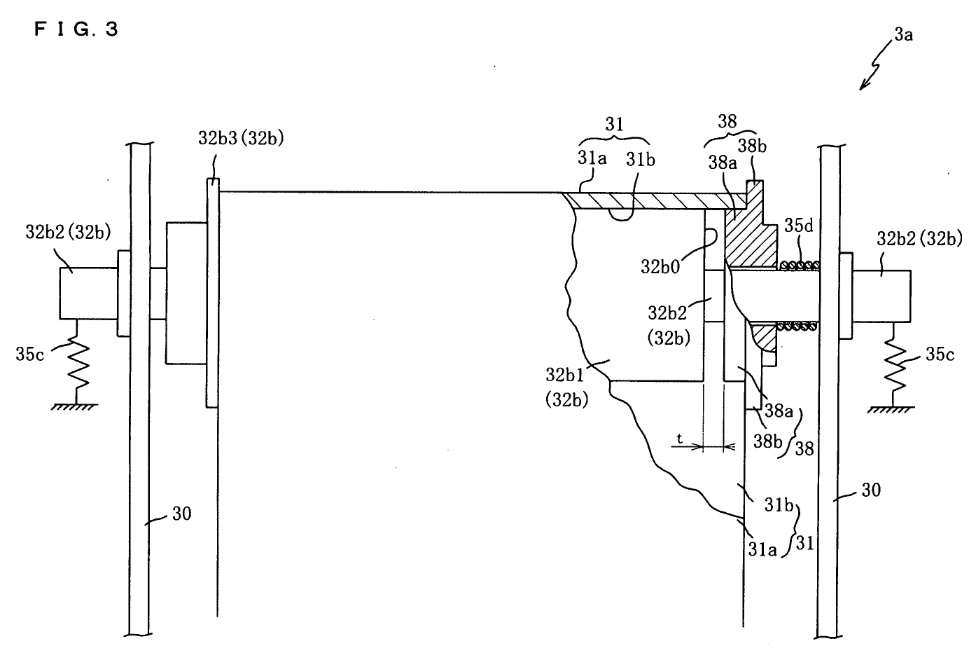

Next, a description will be given of a detailed structure of the driven roller 32b and a support structure thereof, with reference to FIG. 3. FIG. 3 is a partly sectional view of the conveying unit 3a, and corresponds to a top view as seen from the recording head 4 side. It should be noted that, FIG. 3 schematically illustrates the compression spring 35c in a simplifying manner, while omitting the encoder roller 36, the tension roller 37 and the like.

The driven roller 32b corresponds to a cylindrical body made of a resin material, and is structured such as to be provided mainly with a body portion 32b1, a shaft portion 32b2 and a fixed flange portion 32b3, as shown in FIG. 3. The body portion 32b1 corresponds to a portion around which the conveyance belt 31 is wound, and is formed as a large-diameter cylindrical body.

It should be noted that: the body portion 32b1 is provided with a regulation surface 32b0 in an end surface in a facing side (a right side in FIG. 3) to a movable flange portion 38 mentioned below. The regulation surface 32b0 corresponds to a portion which is come into contact with the movable flange portion 38 moving in an axial direction (a left side in FIG. 3) toward the body portion 32b1, and is provided for regulating a movement of the movable flange portion 38.

The shaft portion 32b2 corresponds to a portion pivotally supported to the main body frame 30 so as to be rotatable, and is integrally formed as a coaxial small-diameter cylindrical body with the body portion 32b1, in both end surfaces of the body portion 32b1. Here, the driven roller 32b is urged in a direction (an upper side in FIG. 3) moving apart from the drive roller 32a (see FIG. 2), by the compression spring 35c (the second urging unit) connected to the shaft portion 32b2 (see FIG. 1), as shown in FIG. 3.

The shaft portion 32b2 of the driven roller 32b is pivotally supported to an opening (not shown) in the shape of an elongate hole formed in the main body frame 30, and is pivotally supported so as to be slidable in an urging direction (an upper side in FIG. 3) or a reverse direction thereto (a lower side in FIG. 3) by the compression spring 35c, by using, as the guide, the edge of the opening in the shape of an elongate hole.

Accordingly, since it is possible to apply a predetermined tensile force to the conveyance belt 31 so as to suppress the slip between the conveyance belt 31 and the drive roller 32a, it is possible to securely transmit the rotational drive force of the drive roller 32a to the conveyance belt 31, and it is possible to stably rotate (feed) the conveyance belt 31 at a desired rotational number (speed).

Further, in the case that the driven roller 32b is structured such as to be urged by the compression spring 35c as mentioned above, the structure can be simplified in comparison with the case of urging the drive roller 32a. In other words, since the drive roller 32a is coupled by the drive motor M and the transmission belt 39, it is necessary to structure the drive force transmission mechanism so as to be movable in the urging direction and the reverse direction thereto, in the structure in which the drive roller 32a is urged by the compression spring 35c.

Accordingly, since it is possible to suppress the complication of the structure so as to reduce the parts cost and the assembling cost, by employing the structure in which the compression spring 35c urges the driven roller 32b, it is possible to reduce the product cost as an entire of the image forming apparatus 1. Further, it is possible to improve reliability by simplifying the structure.

Further, if the compression spring 35c is structured such as to urge the driven roller 32b, that is, the driven roller 32b is elastically supported, it is possible to effectively prevent the vibration generated when a portion of the conveyance belt 31, the portion pushed out by the drive roller 32a, is vibrated, from being transmitted to a portion of the conveyance belt 31, the portion on the passing region side of the recording medium P (that is, the side on which the encoder roller 36 is positioned), so as to go around the driven roller 32b, due to the vibration suppressing effect of the elastically supported driven roller 32b.

The fixed flange portion 32b3 (the contact member) corresponds to a portion for suppressing a vibration (a lateral oscillation) in a width direction of the conveyance belt 31, and is integrally formed while protruding in a flange shape in an outer diameter direction from an outer peripheral surface of the body portion 32b1, as shown in FIG. 3, and one side surface (a right side surface in FIG. 3) of the protruding portion is formed as a surface contacting with the end surface of the conveyance belt 31.

As shown in FIG. 3, the movable flange portion 38 (the contact member) is coaxially attached to the shaft portion 32b2 in an opposite side (a right side in FIG. 3) to the fixed flange portion 32b3 of the driven roller 32b. The movable flange portion 38 is mainly provided with a body portion 38a and a disc portion 38b. The body portion 38a corresponds to a portion around which the conveyance belt 31 is wound, as shown in FIG. 3, and is formed as a cylindrical body having the same axis and the same diameter as those of the body portion 32b1 of the driven roller 32b mentioned above.

The disc portion 38b corresponds to a portion for suppressing the vibration (the lateral oscillation) in the width direction of the conveyance belt 31, in the same manner as the fixed flange portion 32b3 mentioned above, is integrally formed in the body portion 38a, and is formed so as to protrude in a flange shape in an outer diameter direction from an outer peripheral surface of the body portion 38a, and one side surface (a left side surface in FIG. 3) of the protruding portion is formed as a surface contacting with the end surface of the conveyance belt 31.

Further, an inner peripheral shape of the movable flange portion 38 is formed in a circular shape having a diameter slightly larger than an outer diameter of the shaft portion 32b2 of the driven roller 32b, and the movable flange portion 38 is structured such as to freely rotate with respect to the shaft portion 32b2 of the driven roller 32b and be slidable along the shaft portion 32b2 (that is, in a horizontal direction in FIG. 3).

A compression spring 35d (a third urging unit) is arranged in a compressed state between the movable flange portion 38 and the main body frame 30, as shown in FIG. 3, and the movable flange portion 38 is urged toward the fixed flange portion 32b3, that is, in a direction in which the movable flange portion 38 and the fixed flange portion 32b3 come close to each other, due to an elastic restoring force of the compression spring 35d.

As mentioned above, in accordance with the conveying unit 3a (the image forming apparatus 1) in the present embodiment, since the movable flange portion 38 is elastically supported, it is possible to effectively suppress the vibration (the lateral oscillation) in the width direction of the conveyance belt 31 due to the vibration suppressing effect caused by the elastic support.

Further, since it is possible to enlarge and contract a gap of the facing surface between the movable flange portion 38 and the fixed flange portion 32b3 if the movable flange portion 38 is structured such as to be elastically supported, as mentioned above, it is possible to absorb a dimensional difference in the respective members, for example, a dimension in the width direction of the conveyance belt 31, a thickness of both the flange portions 32b3 and 38 and the like.

Accordingly, it is possible to stabilize the contact state between the conveyance belt-31 and both the flange portions 32b3 and 38 so as to securely suppress the vibration (the lateral oscillation) in the width direction of the conveyance belt 31. Further, if it is possible to absorb the dimensional difference as mentioned above, it is possible to slack a dimensional tolerance of each of the members such as the conveyance belt 31 and the like. Accordingly, it is possible to reduce a manufacturing (management) cost so as to reduce the product cost as an entire of the image forming apparatus 1 at that degree.

Here, if the fixed flange portion 32b3 and the movable flange portion 38 (the disc portion 38b) contact with the end surfaces in both sides in the width direction of the conveyance belt 31 respectively on the basis of the urging force of the compression spring 35d, as shown in FIG. 3, a gap t is formed between a regulation surface 32b0 of the driven roller 32b and the movable flange portion 38 (the body portion 38a).

If the gap t is formed between the regulation surface 32b0 of the driven roller 32b and the movable flange portion 38 as mentioned above, it is possible to always apply the urging force by the compression spring 35d to the end surface of the conveyance belt 31 via the fixed flange portion 32b3 and the movable flange portion 38. Accordingly, it is possible to securely suppress the vibration (the lateral oscillation) in the width direction of the conveyance belt 31.

It should be noted that it is preferable to set the gap t mentioned above in a range from equal to or more than about 0.2 mm to equal to or less than about 0.8 mm. The gap t is secured to be equal to or more than about 0.2 mm because it is possible to avoid the contact between the regulation surface 32b0 of the driven roller 32b and the movable flange portion 38 even when the conveyance belt 31 is curved due to the great vibration (lateral oscillation) in the width direction (that is, even when the dimension in the width direction is reduced due to the ruffling). Accordingly, since the urging force by the compression spring 35d is always applied to the end surface of the conveyance belt 31 via both the flange portions 32b3 and 38, it is possible to securely suppress the vibration (the lateral oscillation) in the width direction of the conveyance belt 31.

On the other hand, the gap t is set to be equal to or less than about 0.8 mm because it is possible to make the length of a portion of the conveyance belt 31 which is not wound around the outer peripheral surface of the body portion 32b1 of the driven roller 32b or the body portion 38a of the movable flange portion 38 sufficiently short. Accordingly, it is possible to suppress a reduction of rigidity strength of the portion of the conveyance belt 31 so as to easily achieve the vibration suppressing effect caused by both the flange portions 32b3 and the 38 and the urging force of the compression spring 35d.

Next, a description will be given of a detailed structure of the control unit 100 with reference to FIG. 4. FIG. 4 is an electric block diagram of the control unit 100. The control unit 100 is provided with a CPU corresponding to an arithmetic processing unit, an ROM in which a program executed by the CPU and data used in the program are stored, an RAM for temporarily storing the data at a time of executing the program, and the other logic circuits (all of them being not shown), and they function integrally, whereby a function unit described below is constructed.

The control unit 100 is provided with a head control unit 101 controlling an ejection of the ink from the recording heads 4, and a motor control unit 104 controlling a drive of the drive motor M, as shown in FIG. 4. It should be noted that each of the function units corresponds to a hardware structured by ASIC or the like, however, all or a part of the function unit may be structured by a software.

The head control unit 101 is provided with an ink ejection timing determining unit 102, and a pulse generating unit 103. The ink ejection timing determining unit 102 is structured such as to control an ejection timing of the ink to be ejected by the recording heads 4 on the basis of the image data to be formed on the recording medium P. Further, the ink ejection timing determining unit 102 changes the ink ejection timing for compensating a displacement of the conveyance belt 31 and a difference of the conveying speed, on the basis of a rotational position of the encoder roller 36 detected by an encoder roller rotational position detecting unit 105 mentioned below.

The pulse generating unit 103 generates a drive pulse for driving the recording heads 4 in accordance with the ink ejection timing determined by the ink ejection timing determining unit 102, and supplies the generated drive pulse to the recording heads 4. The recording head 4s eject the ink to the recording medium P every time when the drive pulse is supplied from the pulse generating unit 103.

The motor control unit 104 is provided with an encoder roller rotational position detecting unit 105 and a motor driving unit 106. The encoder roller rotational position detecting unit 105 detects the rotational position of the encoder roller 36 on the basis of the detection result of the optical sensor 61b of the rotary encoder 61. It is possible to detect the position and the conveying speed of the conveyance belt 31 by detecting the rotational position of the encoder roller 36.

The motor driving unit 106 is structured such as to drive the drive motor M on the basis of the rotational position of the encoder roller 36 detected by the encoder roller rotational position detecting unit 105.

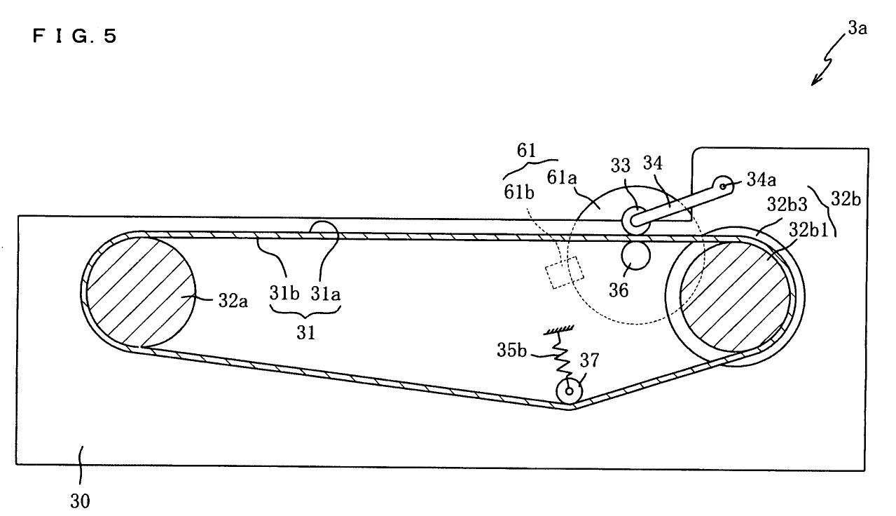

Next, a description will be given of an operation of the conveying unit 3a structured as mentioned above with reference to FIG. 5. FIG. 5 is a sectional side view of the conveying unit 3a taken along a line V-V in FIG. 2. It should be noted that an illustration of the compression spring 35a is omitted in FIG. 5.

When the drive roller 32a is rotated in a predetermined direction (a counterclockwise in FIG. 5) due to the drive force from the drive motor M (see FIG. 2), the conveyance belt 31 is fed in the conveying direction (the counterclockwise in FIG. 5) in accordance with the rotation.

In this case, when rotating the drive roller 32a at a high speed, a tension state is formed in a portion of the conveyance belt 31, the portion pulled by the drive roller 32a, (that is, a portion of the conveyance belt 31, the portion moving toward the drive roller 32a from the driven roller 32b), and a surplus state is formed in a portion of the conveyance belt 31, the portion pushed by the drive roller 32a, (that is, a portion of the conveyance belt 31, the portion moving toward the drive roller 32a from the driven roller 32b). Accordingly, the conveyance belt 31 curves (undulates), and the vibration tends to be generated.

Since the vibration is transmitted to the portion under the tension state of the conveyance belt 31 so as to go around the driven roller 32b, the encoder roller 36 can not follow the fluctuation of the conveyance belt 31 in the conventional product, and there is generated a problem that it is impossible to accurately detect the conveying speed of the conveyance belt 31.

On the contrary, in the conveying unit 3a (the image forming apparatus 1) in the present embodiment, a position at which the tension roller 37 contacts with the inner peripheral surface 31b of the conveyance belt 31 is set so that the length of a portion of the conveyance belt 31 between the driven roller 32b and the tension roller 37 is shorter than the length of a portion of the conveyance belt 31 between the tension roller 37 and the drive roller 32a.

In other words, since the tension roller 37 is arranged at a position (a right side in FIG. 5) coming close to the driven roller 32b rather than the drive roller 32a, it is possible to efficiently prevent the portion pushed out by the drive roller 32a of the conveyance belt 31 from being vibrated, due to the vibration suppressing effect of the tension roller 37, even when feeding the conveyance belt 31 at a high speed.

At the same time, it is possible to efficiently prevent the vibration from being transmitted to the portion of the conveyance belt 31 on the encoder roller 36 side (that is, the passing region side of the recording medium P) so as to go around the driven roller 32b.

As a result, since it is possible to solve the problem in the conventional product, that is, the problem that the encoder roller 36 can not follow the fluctuation of the conveyance belt 31 due to the vibration, it is possible to stably rotate (in an interlocking manner) the encoder roller 36 at the rotational speed corresponding to the conveying speed of the conveyance belt 31, and it is possible to accurately detect the conveying speed of the conveyance belt 31. Accordingly, it is possible to improve the image quality.

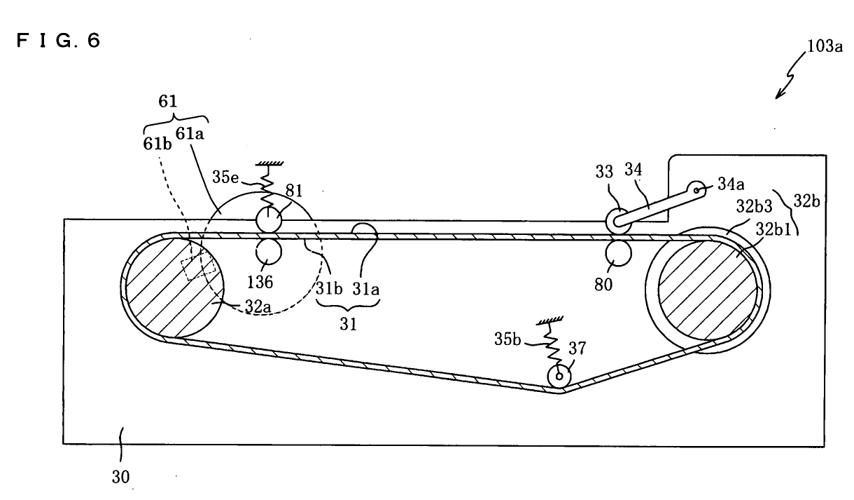

Next, a description will be given of a second embodiment with reference to FIG. 6. FIG. 6 is a sectional side view of a conveying unit 103a according to the second embodiment, and corresponds to the sectional side view taken along the line V-V in FIG. 2.

In the first embodiment, the description is given of the case that the encoder roller 36 is arranged at the position coming close to the driven roller 32b rather than the drive roller 32a. However, in the second embodiment, an encoder roller 136 is arranged at a position coming close to a drive roller 32a rather than a driven roller 32b. It should be noted that the same reference numerals are attached to the same portions as those of the first embodiment mentioned above, and a description thereof will be omitted.

As shown in FIG. 6, a conveying unit 103a in the second embodiment is provided with first and second pinch rollers 80 and 81. The first pinch roller 80 corresponds to a roller for pinching the conveyance belt 31 together with the nip roller 33, and contacts with the inner peripheral surface 31b of the conveyance belt 31 in a lower side of the nip roller 33 (a lower side in FIG. 6). Both ends in an axial direction of the first pinch roller 80 are pivotally supported to the main body frame 30 so as to be rotatable.

The encoder roller 136 is structured in the same manner as the encoder roller 36 in the first embodiment mentioned above, and is pivotally supported to the main body frame 30 so as to be rotatable. The rotary encoder 61 (see FIG. 2) is arranged in one end side in an axial direction thereof, and it is possible to detect the conveying speed of the conveyance belt 31.

The second pinch roller 81 corresponds to a roller for contacting the conveyance belt 31 with the encoder roller 136 closely, and is urged toward the encoder roller 136 from the outer peripheral surface 31a side of the conveyance belt 31. In other words, a compression spring 35e is connected in a compressed state to the second pinch roller 81, as shown in FIG. 6, and the second pinch roller 81 is urged toward a lower side in FIG. 6 due to an elastic restoring force of the compression spring 35e.

Accordingly, the conveyance belt 31 is pinched between the second pinch roller 81 and the encoder roller 136, and the encoder roller 136 closely contacts with the inner peripheral surface 31b of the conveyance belt 31, whereby the encoder roller 136 is rotated (in an interlocking manner) in conjunction with the conveyance belt 31 without rotating freely.

Here, in the second embodiment, the encoder roller 136 is arranged at the position coming close to the drive roller 32a rather than the driven roller 32b (a left side in FIG. 6). In other words, the position at which the encoder roller 136 contacts with the inner peripheral surface 31b of the conveyance belt 31 is set to a position at which the length of a portion of the conveyance belt 31 between the driven roller 32b and the encoder roller 136 is longer than a length of the portion of the conveyance belt 31 between the encoder roller 136 and the drive roller 32a.

Accordingly, it is possible to sufficiently secure the distance from the driven roller 32b to the encoder roller 136 (the length of the conveyance belt 31). Therefore, even when the portion pushed out by the drive roller 32a of the conveyance belt 31 is vibrated, and the vibration is transmitted to the portion of the conveyance belt 31 on the encoder roller 136 side (that is, the passing region side of the recording medium P) so as to go around the driven roller 32b, it is possible to sufficiently damp the vibration until it reaches the encoder roller 136, and it is possible to detect the conveying speed at high accuracy.

Although the configuration has been described and illustrated on the basis of the embodiments, it can be readily understood that it is not limited to the above-mentioned embodiments, and numerous modifications and variations can be devised without departing from the scope.

For example, in each of the embodiments mentioned above, although the description is given of the case that all of the nip roller 33, the tension roller 37, the driven roller 32b, the movable flange portion 38 and the pinch roller 81 are urged by the compression springs 35a to 35e, the compression springs are not necessarily used, and it is understood that other urging means can be used. Examples of other urging means include a tension spring, a torsion spring, a leaf spring and the like.

Further, in each of the above embodiments, the description is given taking the application of the line type printer as an example. However, it is not necessarily limited to this, and can be applied to a so-called serial type printer that records (forms an image) while reciprocating the recording head in a direction orthogonal to conveying direction of a paper (a recording medium).

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

1. An image forming apparatus comprising:
an endless conveyance belt having an outer peripheral surface which serves as a mounting surface of a recording medium;
a drive roller and a driven roller around which said conveyance belt is wound;
a driving unit driving said drive roller;
an encoder roller contacting with a portion of said conveyance belt, said portion moving toward said drive roller from said driven roller;
an encoder detecting a rotational position of said encoder roller;
a tension roller contacting with a portion of said conveyance belt, said portion moving toward said driven roller from said drive roller;
a first urging unit urging said tension roller toward said conveyance belt; and
a recording head ejecting ink to the recording medium conveyed by said conveyance belt,
wherein a position at which said tension roller contacts with said conveyance belt is set to a position at which a length of the conveyance belt between said driven roller and said tension roller is shorter than a length of the conveyance belt between said tension roller and said drive roller.

2. The image forming apparatus according to claim 1, wherein at least an outer peripheral surface of said tension roller is made of an elastic material, and said tension roller contacts with an inner peripheral surface of said conveyance belt.

3. The image forming apparatus according to claim 1, further comprising a second urging unit urging at least one of said drive roller and said driven roller in a direction moving apart from each other.

4. The image forming apparatus according to claim 3, wherein said second urging unit is structured such as to urge said driven roller.

5. The image forming apparatus according to claim 1, further comprising a pair of contact members contacting with end surfaces of said conveyance belt in both sides in a width direction of said conveyance belt respectively.

6. The image forming apparatus according to claim 5, further comprising a third urging unit urging at least one of said pair of contact members in a direction coming close to each other.

7. The image forming apparatus according to claim 6, wherein one of said pair of contact members is integrally formed with said driven roller in one end side in an axial direction of said driven roller,
the other of said pair of contact members is supported so as to be movable in an axial direction of said driven roller in the other end side in the axial direction of said driven roller, and
said third urging unit is structured such as to urge the other of said contact members.

8. The image forming apparatus according to claim 7, wherein said driven roller is provided with a regulation surface coming into contact with the other of said pair of contact members so as to regulate a movement of a case where the other of said pair of contact members moves in said axial direction toward the one, and
a predetermined gap is formed between the regulation surface of said driven roller and the other of said pair of contact members, at a time when said pair of contact members contact with said end surfaces of said conveyance belt respectively due to the urging force of said third urging unit.

9. The image forming apparatus according to claim 8, wherein said predetermined gap is set in a range from equal to or more than about 0.2 mm to equal to or less than about 0.8 mm.

10. The image forming apparatus according to claim 1, further comprising:
a nip roller contacting with the outer peripheral surface of said conveyance belt in a passing region of the recording medium;
a pinch roller contacting with the inner peripheral surface of said conveyance belt for pinching said conveyance belt together with said nip roller; and
a fourth urging unit urging at least one of said nip roller and said pinch roller in a direction coming close to each other,
wherein said encoder roller serves as said pinch roller.

11. The image forming apparatus according to claim 10, wherein said fourth urging unit is structured such as to urge said nip roller.

12. The image forming apparatus according to claim 1, wherein a position at which said encoder roller contacts with said conveyance belt is set to a position at which a length of the conveyance belt between said driven roller and said encoder roller is longer than a length of the conveyance belt between said encoder roller and said drive roller.

13. The image forming apparatus according to claim 1, further comprising a control unit controlling an ejection timing of ink from said recording head, on the basis of a rotational position of said encoder roller detected by said encoder.

14. An image forming apparatus comprising:
an endless conveyance belt having an outer peripheral surface which serves as a mounting surface of a recording medium;
a drive roller and a driven roller around which said conveyance belt is wound;
drive means driving said drive roller;
an encoder roller contacting with a portion of said conveyance belt, said portion moving toward said drive roller from said driven roller;
an encoder detecting a rotational position of said encoder roller;
a tension roller contacting with a portion of said conveyance belt, said portion moving toward said driven roller from said drive roller;
first urging means urging said tension roller toward said conveyance belt; and
a recording head ejecting ink to the recording medium conveyed by said conveyance belt,
wherein a position at which said tension roller contacts with said conveyance belt is set to a position at which a length of the conveyance belt between said driven roller and said tension roller is shorter than a length of the conveyance belt between said tension roller and said drive roller.

15. The image forming apparatus according to claim 14, wherein at least an outer peripheral surface of said tension roller is made of an elastic material, and said tension roller contacts with an inner peripheral surface of said conveyance belt.

16. The image forming apparatus according to claim 14, further comprising second urging means urging at least one of said drive roller and said driven roller in a direction moving apart from each other.

17. The image forming apparatus according to claim 16, wherein said second urging means is structured such as to urge said driven roller.

18. The image forming apparatus according to claim 14, further comprising a pair of contact members contacting with end surfaces in both sides of said conveyance belt in a width direction of said conveyance belt respectively.

19. The image forming apparatus according to claim 18, further comprising third urging means urging at least one of said pair of contact members in a direction coming close to each other.

20. The image forming apparatus according to claim 19, wherein one of said pair of contact members is integrally formed with said driven roller in one end side in an axial direction of said driven roller,
the other of said pair of contact members is supported so as to be movable in an axial direction of said driven roller in the other end side in the axial direction of said driven roller, and
said third urging means is structured such as to urge the other of said contact members.

21. The image forming apparatus according to claim 20, wherein said driven roller is provided with a regulation surface coming into contact with the other of said pair of contact members so as to regulate a movement of a case where the other of said pair of contact members moves in said axial direction toward the one, and
a predetermined gap is formed between the regulation surface of said driven roller and the other of said pair of contact members, at a time when said pair of contact members contact with said end surfaces of said conveyance belt respectively due to the urging force of said third urging means.

22. The image forming apparatus according to claim 21, wherein said predetermined gap is set in a range from equal to or more than about 0.2 mm to equal to or less than about 0.8 mm.

23. The image forming apparatus according to claim 14, further comprising:
a nip roller contacting with the outer peripheral surface of said conveyance belt in a passing region of the recording medium;
a pinch roller contacting with the inner peripheral surface of said conveyance belt for pinching said conveyance belt together with said nip roller; and
fourth urging means urging at least one of said nip roller and said pinch roller in a direction coming close to each other,
wherein said encoder roller serves as said pinch roller.

24. The image forming apparatus according to claim 23, wherein said fourth urging means is structured such as to urge said nip roller.

25. The image forming apparatus according to claim 14, wherein a position at which said encoder roller contacts with said conveyance belt is set to a position at which a length of the conveyance belt between said driven roller and said encoder roller is longer than a length of the conveyance belt between said encoder roller and said drive roller.

26. The image forming apparatus according to claim 14, further comprising a control unit controlling an ejection timing of ink from said recording head, on the basis of a rotational position of said encoder roller detected by said encoder.
